(19) United States
(12) Patent Application Publication
(10) Pub. No.: US 2023/0036721 A1
(43) Pub. Date: Feb. 2, 2023

(54) METHODS AND SYSTEMS FOR MANAGING CONTENT IN REPOSITORIES

(71) Applicant: ProjectReady Central LLC, White Plains, NY (US)

(72) Inventor: Joseph Giegerich, Bronx, NY (US)

(21) Appl. No.: 17/386,131

(22) Filed: Jul. 27, 2021

(51) Int. Cl. G06F 21/62; G06F 16/21

(52) U.S. Cl. CPC G06F 21/6218; G06F 16/21

(57) ABSTRACT

A management apparatus for managing content for a plurality of repositories including a first repository and a second repository, the management apparatus includes a processor and a memory including instructions stored thereon. The instructions, when executed by the processor, cause the management apparatus to receive an access token from an identity server for a user, wherein the access token allows the user to login to the plurality of repositories via the management apparatus, receive first content for the first repository and second content for the second repository from the user, receive metadata for the first content and the second content from the user, add the metadata to the first content and the second content, and upload the first content and the second content with the metadata to the first repository and the second repository, respectively.

### BACKGROUND

### Technical Field

The present disclosure relates to methods and systems for managing content in repositories. More particularly, the present disclosure relates to methods and systems that manages metadata of content saved in repositories.

### Background of Related Art

Generally, when a project is started, there are one or more phases, during which several companies, budget planning, different people, different types of work, different types of documents, different types of platforms, and different levels of securities are required. As shown in FIG. 1, when a project 100 is created, names or job titles 110 for people need to be set. Also, security levels 120 in hierarchical order should be set for each person to set a scope of responsibilities. The project 100 can be subdivided into several phases 130₁-130_{L} so that each sub project is kept in manageable size. For example, when a building is to be constructed as the project 100, a design and blueprints as phase 130₁ are required, building permits as phase 130₂ should be obtained from local governments, excavation as phase 130₃ need to be performed to clear land, foundation as phase 130₄ is to be laid, framing of the building as phase 130₅ is to be initiated, etc.

At each phase of the project 100, different companies are involved, and different types of documents are to be created, saved, and updated at document repositories. Related budget information is to be assigned to each phase. Further, based on the characteristics of each phase, the contractors or companies may use different document repositories. A project manager needs to check the current status of the project or phases. In order to do such, documents, which have been prepared for the project, are supposed to be continuously updated along advancement of the project or phases and the project manager needs to look at the documents to check the up-to-dated status. Since documents may be saved on different repositories based on the characteristics of phases and the respective companies' preferences, the project manager needs to visit each of the repositories, use different applications to look at the documents, and check the status of each phase. Due to various requirements by different repositories, the project manager needs to use respective login information, follow different verification processes, and use various applications to access documents saved therein. Thus, management burdens have been accumulated as the project becomes complicated.

### SUMMARY

According to various aspects of the present disclosure, a management apparatus for managing content for a plurality of repositories including a first repository and a second repository is disclosed. The management apparatus includes a processor and a memory including instructions stored thereon. The instructions, when executed by the processor, cause the management apparatus to receive an access token from an identity server for a user, wherein the access token allows the user to login to the plurality of repositories via the management apparatus, receive first content for the first repository and second content for the second repository from the user, receive metadata for the first content and the second content from the user, add the metadata to the first content and the second content, and upload the first content and the second content with the metadata to the first repository and the second repository, respectively.

According to aspects of the present disclosure, the access token expires after a first predetermined period. The access token is to be refreshed after expiration. The refreshed token expires after a second predetermined period.

According to aspects of the present disclosure, the access token is not saved in the management apparatus.

According to aspects of the present disclosure, the instructions, when executed by the processor, further cause the management apparatus to receive a change in metadata of content uploaded to a repository from the user and upload the content with the change in metadata to the repository.

According to aspects of the present disclosure, the first content and the second content are related to a project and a group of project members.

According to aspects of the present disclosure, the management apparatus does not save the first content, the second content, and the metadata in the management apparatus.

According to aspects of the present disclosure, the access token includes location information and login information of the plurality of repositories.

According to aspects of the present disclosure, the login information is retrievable from the access token.

According to aspects of the present disclosure, the plurality of repositories are incompatible from each other.

According to various aspects of the present disclosure, a method for controlling a management apparatus, which manages content for a plurality of repositories including a first repository and a second repository is disclosed. The method includes receiving an access token from an identity server for a user, wherein the access token allows the user to login to the plurality of repositories via the management apparatus, receiving first content for the first repository and second content for the second repository from the user, receiving metadata for the first content and the second content from the user, adding the metadata to the first content and the second content, and uploading the first content and the second content with the metadata to the first repository and the second repository, respectively.

According to aspects of the present disclosure, the access token expires after a first predetermined period.

According to aspects of the present disclosure, the access token is to be refreshed after expiration.

According to aspects of the present disclosure, the refreshed token expires after a second predetermined period.

According to aspects of the present disclosure, the access token is not saved in the management apparatus.

According to aspects of the present disclosure, the method further includes receiving a change in metadata of the content uploaded to a repository from the user, and uploading the content with the change in metadata to the repository.

According to aspects of the present disclosure, the first content and the second content are related to a project and a group of project members.

According to aspects of the present disclosure, the first content, the second content, and the metadata are not saved in the management apparatus.

According to aspects of the present disclosure, the access token includes storing location information and login information of the plurality of repositories.

According to aspects of the present disclosure, the login information is retrievable from the access token.

According to aspects of the present disclosure, the plurality of repositories are incompatible from each other.

According to various aspects of the present disclosure, a nontransitory computer readable medium having instructions thereon that, when executed by a processor, cause the processor to perform a method for controlling a management apparatus, which manages content for a plurality of repositories is disclosed. The method includes receiving an access token from an identity server for a user, wherein the access token allows the user to login to the plurality of repositories via the management apparatus, receiving first content for the first repository and second content for the second repository from the user, receiving metadata for the first content and the second content from the user, adding the metadata to the first content and the second content, and uploading the first content and the second content with the metadata to the first repository and the second repository, respectively.

### BRIEF DESCRIPTION OF THE DRAWINGS

The present disclosure may be understood by reference to the accompanying drawings, when considered in conjunction with the subsequent, detailed description, in which:

FIG. 1 is a block diagram for creating and organizing a project;

FIG. 2 is a block diagram of a system for managing metadata of content to be saved at repositories according to various aspects of the present disclosure;

FIGS. 3A-3E are graphical illustrations for adding/revising common metadata and uploading the metadata according to various aspects of the present disclosure;

FIG. 4 is a flowchart of a method for managing metadata of documents according to various aspects of the present disclosure; and

FIG. 5 is a block diagram of a computing device according to various aspects of the present disclosure.

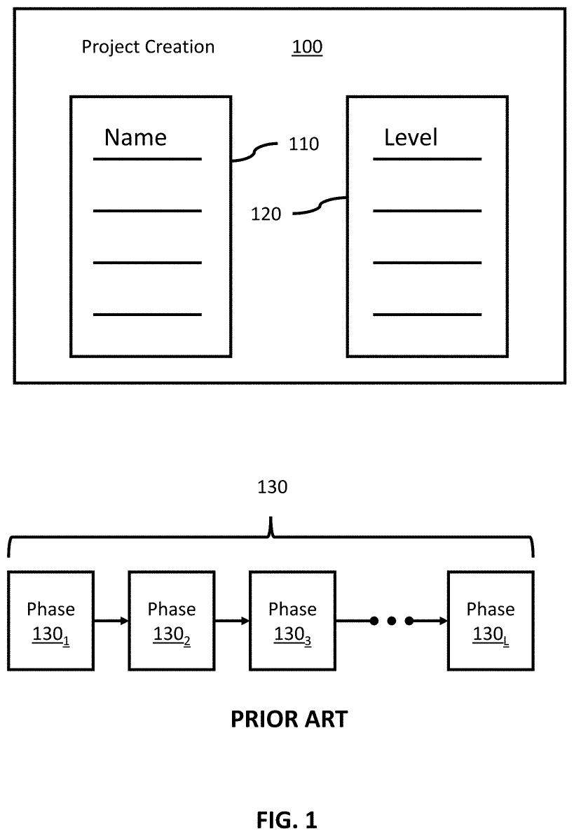

### DETAILED DESCRIPTION

Aspects of the presently disclosed management systems and devices are described in detail with reference to the drawings, in which like reference numerals designate identical or corresponding elements in each of the several views.

The term “application” may include a computer program designed to perform functions, tasks, or activities for the benefit of a user. Application may refer to, for example, software running locally or remotely, as a standalone program or in a web browser, or other software which would be understood by one skilled in the art to be an application. An application may run on a controller, or on a user device, including, for example, a mobile device, an Internet of thing (IoT) device, a server system, or any programmable logic device.

The term “content” and “document(s)” in this disclosure may include any digitized files with texts and/or graphics, and the term “metadata” may include information of the content and/or documents and related information (e.g., budget, priority, date of creation, etc.) of a project or sub-project, to which the content and/or documents directed.

In the following description, well-known functions, or implementation of such are not described in detail to avoid obscuring the present disclosure in unnecessary detail. Those skilled in the art will understand that the present disclosure may be adapted for use with cloud-based server-client networks, peer-to-peer network systems, intranet systems, and internet-based network systems. It should also be appreciated that different network protocols and other considerations may apply to each particular type of methods or systems.

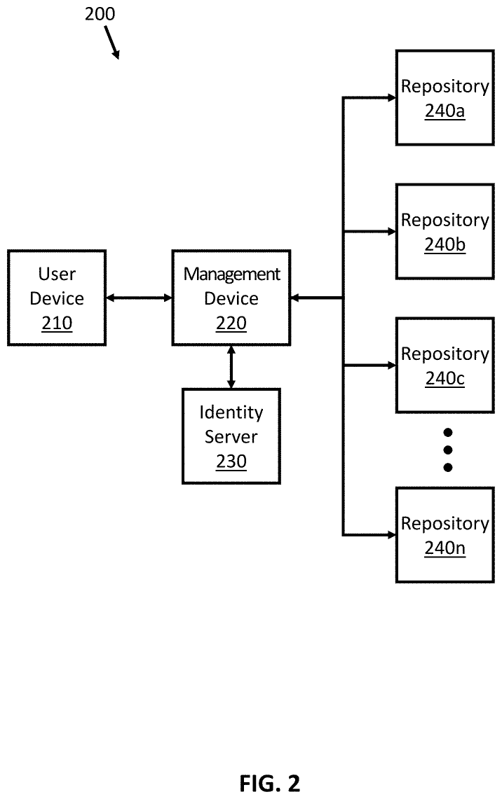

FIG. 2 illustrates a management system 200 for managing metadata of content, which is to be saved or has been saved at repositories according to various aspects of the present disclosure. The management system 200 may include a user device 210, a management device 220, an identity server 230, and document repositories 240a-240n. When a user uses his/her own device or other computing device 210 to access the management device 220, the user inputs login information to the management device 220. In aspects, the user device 210 may be a smart device, mobile phone, tablet, or web application.

The communication within the management system 200 may be encrypted to secure communication data. Further, any data saved at the user device 210, the management device 220, the identity server 230, and the repositories 240a-240n may also be encrypted. In other words, data or content saved at the user device 210, the management device 220, the identity server 230, and the repositories 240a-240n are encrypted in transit and at rest. For example, encryption in transit may use Transport Layer Security (TLS) and Secure Sockets Layer (SSL), which encrypts the data being transmitted so that a third party cannot eavesdrop on the transmission and view the data being transmitted. TLS 1.2 or 1.3 may be used in encryption and/or the SSL may use 40-bit, 128-bit, or higher encryption. The encryption protocol is not limited to this list but can encompass other encryption protocols, which can be readily apprehended by a person of skilled in the art.

In aspects, data saved in the user device 210, the management device 220, the identity server 230, and the repositories 240a-240n may be also encrypted while residing therein. The encryption may be done by Advanced Encryption Standard (AES) with a fixed block size of 128 bits, and a key size of 128, 192, or 256 bits. The size of the fixed block and the size of the key may not be limited to these sizes but can be increased or decreased to meet security requirements. Any communication described below is presumed to be encrypted in transit and data or content saved at the user device 210, the management device 220, the identity server 230, and the repositories 240a-240n are also presumed encrypted at rest.

In response to the input of the login information, the management device 220 may request the identity server 230 for an access token. Since the management device 220 does not store login information for the repositories 240a-240n and web addresses of the repositories 240a-240n, content information saved at the repositories 240a-240nmay be securely maintained from any unauthorized attempts from the management device 220.

When the identity server 230 receives the login information from the management device 220, the identity server 230 looks for access information corresponding to the login information. In aspects, the access information may include login information for the repositories 240a-240n, web addresses of the repositories 240a-240n, or any other information which enables the user to access content saved in the repositories 240a-240n. Since the access information is not saved in the management device 220, the content saved in the repositories 240a-240n are secured. Further, the communications between the management device 220 and the identity server 230 are secured or encrypted to increase security in the user device 210. In aspects, the identity server 230 may be a server, which can be connected through intranet or Internet, with a wired connection or wirelessly.

In aspects, the identity server 230 may provide the access token with encryption, and the management device 220 may not be able to decrypt the encryption of the access token. Thus, anyone who obtains an access to the management device 220 may not be able to directly use the access token to obtain the login information of the repositories 240a-240n therefrom without knowing the encryption-decryption mechanism, which is used between the identity server 230 and the repositories 240a-240n.

In aspects, the access token may expire after a predetermined period after the identity server 230 sends out to the management device 220. The predetermined period may be 10, 20 minutes, 1 hour, or more. The access token may be re-used while the access token is being used during the predetermined period. However, the access token may be refreshed even during a continuous usage after another predetermined period. For example, the predetermined period for refreshment may be 1 day or 2 days, which is much longer than the period for expiration.

The user may access the management device 220 via an application (e.g., a web browser, a designated communication application, etc.) installed in the user device 210 and manage content saved in the repositories 240a-240n. Specifically, the management device 220 may transmit the access token to any one of the repositories 240a-240n, and the repositories 240a-240n decrypts the access token and allows the user to access content saved at the depository, if one piece of information obtained from the decrypted access token matches the login information of the depository. The content may include documents, which include digitized textual or graphical information, audios, videos, or any other types of files. The documents may be Microsoft™ files (e.g., word, powerpoint, excel, access, visio, or other files), graphic files (e.g., jpg, gif, bmp, svg, png, or other graphic format files), html files, pdf files, files in Autodesk Revit formats, DWG files, and the like. Formats of the documents are not limited to this list but may include other formats as needed based on characteristics of the project or as contemplated by persons having skilled in the art.

The management device 220 may be able to manage content saved at the repositories 240a-240n. The user may access the content through the management device 220 by using the access token. In this regard, the management device 220 may use the access token to retrieve information from the repositories 240a-240n to see content saved at the repositories 240a-240n. However, at this time, the management device 220 does not locally save the content, which have been saved at the repositories 240a-240n but may operate as an intermediary to relay the information of the content between the user device 210 and the repositories 240a-240n.

To see inside information of the content saved at the repositories 240a-240n, the content need to be opened. While the name of the content may include general information thereof, the name cannot include all the information of the content. In this regard, metadata may be saved within the content and include related information of the content so that the user may be able to look at the related information without actually opening the content. Further, even in a case when the user device 210 or the management device 220 does not have a suitable program to open and see the inside information of the content, the user device 210 or the management device 220 still may be able to look at the metadata.

In aspects, the metadata may include information of documents in consideration of a project. For example, when the project is a construction, the metadata may include a budget allocated to a sub-project (e.g., blueprint, excavation, foundation, framing, leasing, etc.) related to the document, a client's name of the sub-project, the date of creation, a document type, priority, a number of revisions, the date of submission, etc. This list is just an example and can include other related information as needed or required by the project.

The user device 210 may be able to upload documents of the user with corresponding metadata to the repositories 240a-240n via the management device 220. When a project is created, the user may create documents related to the project. These documents may be saved locally at the user device 210, a cloud storage, an external storage, or any other storage medium.

The repositories 240a-240n may provide a storage medium for saving documents therein, a certain level of security on the saved data, interfaces between users and the corresponding repository, and other functionalities suited for user's needs. For examples, a first repository (e.g., BIM 360® or Autodesk®) provides a design functionality to aid users to use different computer-aided design tools (e.g., AutoCAD®, Revit®, etc.), and also provides a storage place so that users save relevant documents. A second repository (e.g., SharePoint®) may allow an enterprise to store, retrieve, search, archive, track, manage, and report on digitized documents (e.g., Microsoft® files). A third repository (e.g., MS Teams®) may provide workspace chat and videoconferencing, file storage, and application integration. A fourth repository (e.g., BOX®) may provide cloud content management and file sharing service for businesses. A fifth repository (e.g., Procore®) may provide construction-related application readily useable for mobile users. The list of these repositories is just an example and can include other repositories.

As described above, the repositories 240a-240n may not be compatible to each other so that users at one repository might be unable to access another repository. Specifically, users who are currently using one repository might not be able to concurrently use other non-compatible repository. Further, different repositories may require different requirements for password and identification (ID). Thus, users of multiple repositories might have to have different IDs and passwords.

In aspects, the management device 220 may utilize a single sign-on (SSO) feature by using the access token to access multiple repositories without remembering respective IDs and passwords. Furthermore, the management device 220 may provide metadata-related functionalities so that users can create, change, revise, update, and manage metadata for documents to be saved on multiple repositories. In particular, common metadata may be created for multiple documents and uploaded with multiple documents to respective repositories by the management device 220. In other words, the management device 220 may enable the user to create common metadata for documents and to upload each document with the common metadata to each respective repository.

In aspect, the management device 220 may enable the user to update/change/revise the common metadata suitable for each project or sub-project after creating the common metadata, and to upload them to repositories. Further, the user may be able to look at metadata of documents previously saved at the repositories 240a-240n and to edit/update/delete/revise the metadata via the management device 220.

When uploading documents, the management device 220 does not locally save the documents to be uploaded. Rather, the management device 220 may receive links of the documents from the user device 210, receive metadata for the documents from the user, add the metadata to the documents, and provide the links with the metadata so that the corresponding repositories may be able to retrieve and save the documents with the metadata via the links.

In aspects, the metadata may be added to a document by a local computing device where the document is saved. In this case, the management device 220 sends the metadata to the local computing device by using the corresponding link and a suitable application is initiated by the local computing device to add the metadata to the document and save the document at the local storage.

In another aspects, the metadata may be added to a document by a repository. In this case, the management device 220 sends a link of the document with the metadata to the repository. Then, the repository retrieves the document via the link, and a suitable application is initiated to add the metadata to the document and save the document at the repository. In all cases, the management device 220 does not save the metadata or the documents at the management device 220 and the document, which incorporates the metadata therewithin, is saved at the local computing device or the repositories 240a-240n. Hence, the management device 220 provides a separate layer from the repositories 240a-240n and the user device 210 and securely connects the user device 210, the management device 220, and the repositories 240a-240n so that privacy and security within the management system 200 are preserved and the management system 200 provides metadata management functionalities to users among the user device 210, the management device 220, and the repositories 240a-240n.

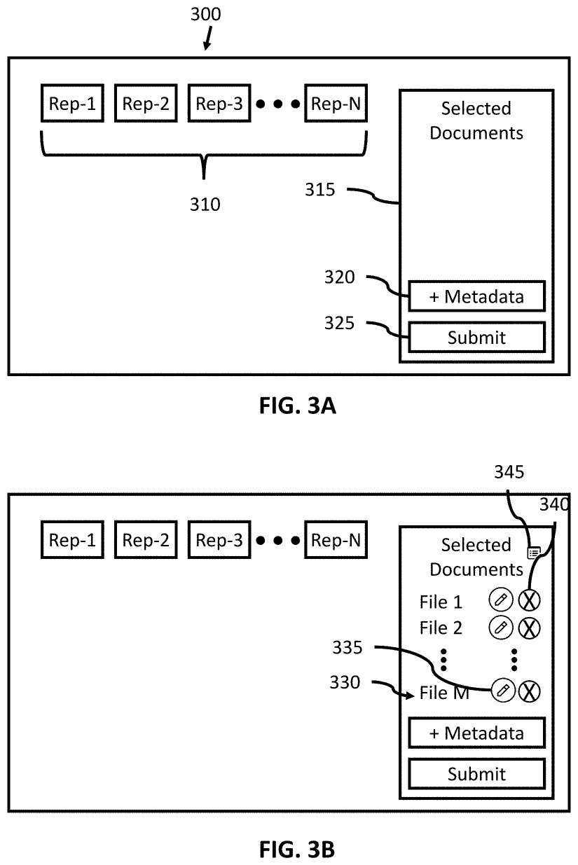

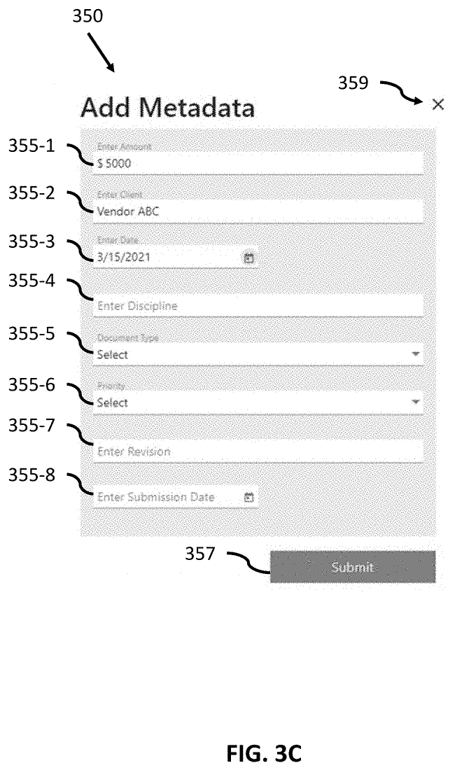

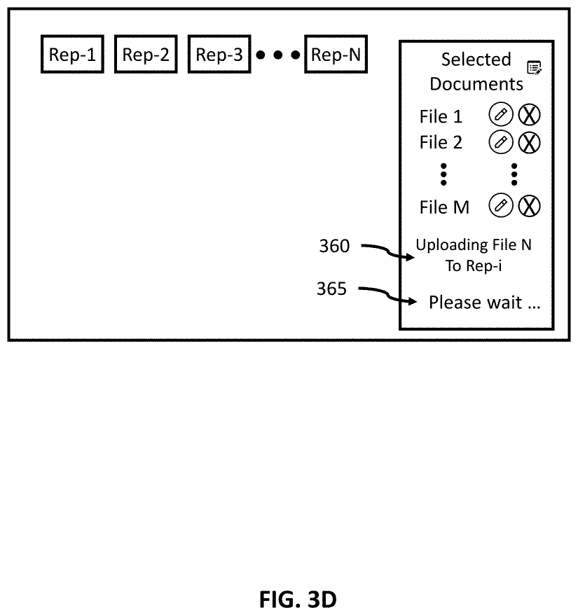

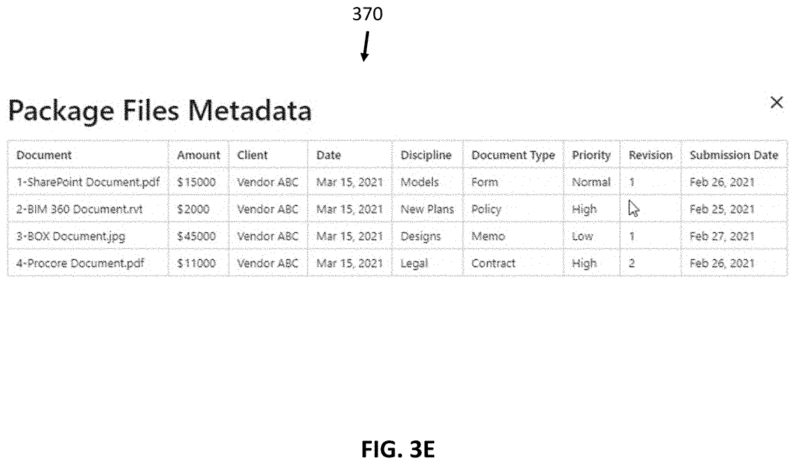

FIGS. 3A-3C are graphical illustrations showing processes for adding common metadata to a package of files according to aspects of the present disclosure. In aspects, FIGS. 3A-3C may be also applied for editing, revising, updating, removing, and adding metadata to the package of files before or after the metadata is uploaded to repositories. When a user logs into the management device 220 and tries to add metadata to documents, which are to be saved at the repositories 240a-240n, the management device 220 pops up a file package management window 300, which includes repository icons 310, a document window 315, a metadata button 320, and a submit button 325. The number of the repository icons 310 may corresponds to the number of repositories that the contractors or companies, which performs the project, employ.

The document window 315 is displayed within the file package management window 300 and is to display file names, which the user intends to upload to the repositories 240a-240n. The metadata button 320 is pressed to add common metadata to the files displayed within the document window 315, and the submit button 325 is pressed to submit/upload the files to the repositories.

To select a file, the user first select a repository, for example, Rep-1, among the repository icons 310. After selecting the repository, another window is popped up so that the user can search for and select a file, which is to be uploaded to Rep-1. The file can be selected from the user's local computing device, a network server, a cloud server, or a mobile device, any device connectable to the user.

After selecting all or M files, corresponding M file names 330 are displayed within the document window 315. The selected M files may not be uploaded to the management device 220 but rather the links to the selected M files are transmitted to the management device 220. Each of the M file names 330 is connected to one of the repositories 310 based on the selected repository. As illustrated in FIG. 3B, next to each of the M file names 330, an edit icon 335 and a remove button 340 are positioned. Also, when one or more files are selected, a preview button 345 is also showed up within the document window 315 and over the M file names 330.

After completing selection of the M files, the metadata button 320 can be clicked to add common metadata to the M files, and an add metadata window 350 pops up as illustrated FIG. 3C. The add metadata window 350 includes one or more fields, which are common to the M files, even though the values or information in each field may be different from each file. These fields can be customizable based on characteristics of documents to be selected or based on the project or phases of the project. For example, an amount field 355-1 is to allot a budget for a portion of a project related to the file, a client field 355-2 is for entering a name of a client, a date field 355-3 is to enter the date of creation of the metadata or the file or files, a discipline field 355-4 is to enter an area of work or project, a document field 355-5 is to enter a type of the file, a priority field 355-6 is to enter a priority of the file, a revision field 355-7 is to enter a number of revisions, and a submission date field 355-8 is to enter the submission date of the file. For some fields, there is a drop-down menu including a predetermined list. For example, the priority field 355-6 can be selected from a predetermined list including high, normal, or low. Date fields 355-3 and 355-8 may have a calendar icon, which can be used to easily select a date. The fields shown in the add metadata window 350 are not limited to this list but may include other fields as contemplated by persons having skilled in the art in consideration of characteristics of the project and phases. Further, after the fields have been set, the manager of the project or phases may be able to add, remove, revise, update, or edit the fields along development of the project or phases.

After information is entered to each field, a submit button 357 may be clicked to confirm the entered metadata as the common metadata for the M files. Or the user can click an exit icon 359 to cancel the entered information as the common metadata.

Now referring back to FIG. 3B, after confirming the entered information as the common metadata, the submit 325 is clicked to submit the M files with the common metadata to the repositories. FIG. 3D illustrates uploading progress. As illustrated, while uploading the files, label 365, “please wait . . . ”, is displayed to show that upload is in progress, and label 360 shows which file is currently being uploaded to which depository.

Now, referring back to FIG. 3B again, the edit icon 335 may be selected to modify the common metadata specifically for a file. When the edit icon 355 is selected, a window similar to the add metadata window 350 is displayed and information in each field can be changed/edited/revised for an individual file by the user. The preview icon 345 may be selected to show a preview window 370 showing the revised metadata for each file as illustrated in FIG. 3E.

When all necessary files are uploaded with the metadata, a manager or related personnel can see them in their capacity through different workflow or repositories. For example, a director who directs the whole project can see and manage all files with metadata throughout all workflows and repositories, and a manager who manages one phase of the project can see and manage files with metadata, which are related to the phase, throughout related workflows and repositories.

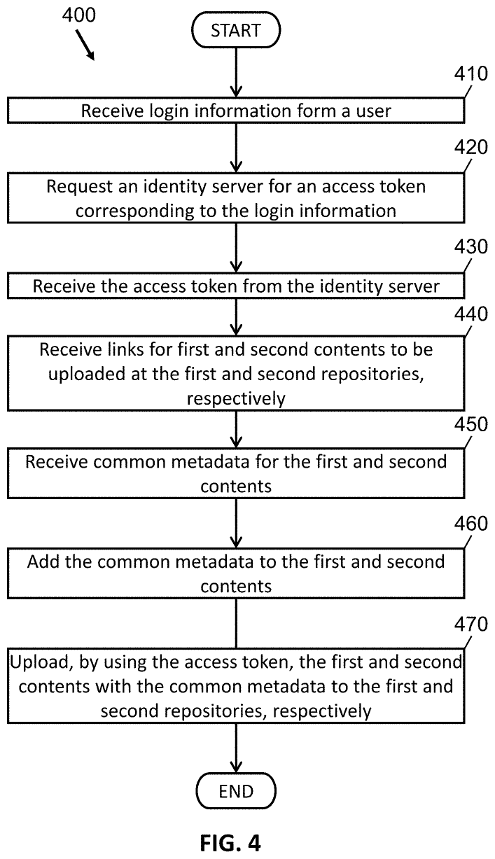

FIG. 4 illustrate a method 400 for managing metadata for files to be uploaded to repositories according to aspects of the present disclosure. The method 400 is started when a metadata management device receives login information from a user device at step 410. In response, the metadata management device send a request to an identity server for an access token based on the login information at step 420. The access token may be used to login to the repositories without using separate login information for each repository. In other words, a single sign-on to a metadata management device enables the user to automatically log in to the repositories. In this regard, the access token may include a web address and login credential of each repository.

At step 430, the identify server provides and the metadata management device receives the access token. Since the access token is encrypted while being stored at the identify server, and transmission of the access token is also encrypted, potential eavesdroppers or ill-minded crackers might not be able to easily decrypt the access token and access the repositories and the corresponding login credentials.

At step 440, the metadata management device receives links for content, where the content is to be uploaded or saved at repositories, from the user. To convey the scope of this disclosure with ease and simplicity without losing generality, phrases “first” and “second” are used for links, content (e.g., files, documents, digitized data, etc.), and repositories in the method 400 but are meant to represent all the links, content, and repositories.

The first and second links may be hyperlinks to the first and second content to be uploaded to the first and second repositories, respectively. Since the first and second content are not uploaded to the metadata management device, potential tampering to the metadata management device might not lead to tampering the first and second content saved at the first and second repositories.

At step 450, the metadata management device also receives common metadata for the first and second content from the user via a user's computing device. The received common metadata is added to the first and second content at step 460 by the metadata management device. In aspects, since the metadata management device receives not the first and second content but the links thereto, addition of the common metadata may be performed at the document repositories where the first and second content reside. For example, the metadata management device may cause/control the user's local device to add/revise the common metadata to the first and second content.

At step 470, the metadata management device accesses the depositories by using the access token and uploads the first and second content with the common metadata to the first and second repositories, respectively.

In aspects, the common metadata may be revised or updated according to characteristics of each sub-project and along advancement of the project. Specifically, in this case, the first and second links in step 440 may be addresses of the first and second repositories, step 450 may be replaced with receiving updated metadata for the first and second content from the user, and step 460 may be replaced with updating the metadata of the first and second content by the first and second repositories.

In aspects, the common metadata may be reviewed, revised, edited, added, rejected, removed, updated, or approved by a manager or receiving part before uploaded to the repositories. Further, after uploaded to the repositories, the common metadata or metadata specific to each phase of the project may be revised, updated, added, or removed along development of the project by the manager or a person in charge of the project or phases of the project.

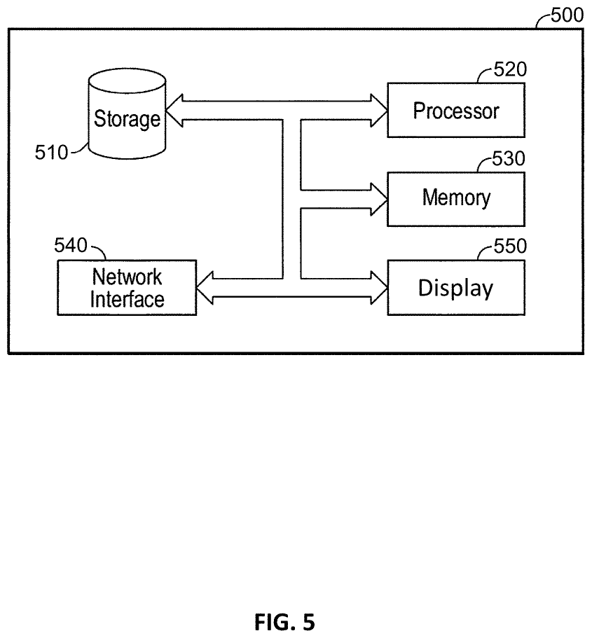

FIG. 5 illustrates a computing device 500 (e.g., a computer, server, laptop, mobile device, cloud, etc.) for controlling the various aspects of the management device 220 of FIG. 2, the identity server 230, and/or repositories 240a-240n of FIG. 2). For instance, the algorithm for managing metadata of content saved in repositories can be performed by the computing device 500. The computing device 500 may include a processor 520 connected to a computer-readable storage medium 510 or a memory 530. The computer-readable storage medium 510 or memory 530 may be one or more physical apparatus used to store data or programs on a temporary or permanent basis. Further, the memory 530 stores suitable instructions, to be executed by the processor 520, for receiving data from a user's web browser, application program, or local computing device, accessing storage 510 of the computing device 500, processing the data, and performing controls/methods (e.g., the method 400 of FIG. 4) for managing metadata for content, which are to be saved or have been saved at repositories 240a-240n of FIG. 2.

In aspects of the disclosure, the computer-readable storage medium 510 or the memory 530 can be random access memory, read-only memory, magnetic disk memory, solid-state memory, optical disc memory, and/or another type of memory. In some aspects of the disclosure, the memory 530 can be separate from the computing device 500 and can communicate with processor 520 through communication buses of a circuit board and/or through communication cables such as serial ATA cables or other types of cables.

In various aspects, the memory 530 may include non-volatile memory, which retains stored information when it is not powered. In some aspects, the non-volatile memory includes flash memory. In certain aspects, the non-volatile memory may include dynamic random-access memory (DRAM). In some aspects, the non-volatile memory may include ferroelectric random-access memory (FRAM), and phase-change random access memory (PRAM), CD-ROMs, DVDs, flash memory devices, magnetic disk drives, magnetic tapes drives, optical disk drives, and cloud-computing-based storage. In various aspects, the storage and/or memory device is a combination of devices such as those disclosed herein.

In various aspects of the disclosure, the computing device 500 may include any type of computing device, computational circuit, or any type of processor or processing circuit capable of executing a series of instructions that are stored in memory. The processor 520 may be another type of processor such as, without limitation, a digital signal processor, a microprocessor, an ASIC, a graphics processing unit (GPU), a field-programmable gate array (FPGA), or a central processing unit (CPU). The computing device 500 may include multiple processors and/or multicore central processing units (CPUs) and may include any type of processor, such as a microprocessor, digital signal processor, microcontroller, programmable logic device (PLD), field programmable gate array (FPGA), or the like.

In aspects of the disclosure, the computing device 500 may include a network interface 540 to communicate with other computers or to a server. As used herein, the network interface 540 may include any network technology including, for instance, a cellular data network, a wired network, a fiber-optic network, a satellite network, and/or an IEEE 802.11a/b/g/n/ac wireless network, among others.

In various aspects, the network interface 540 may be applied to both wired and wireless networks. Wireless mesh networks can be considered a type of “Wireless ad hoc” network. Thus, wireless mesh networks are closely related to Mobile ad hoc networks (MANETs). Although MANETs are not restricted to a specific mesh network topology, Wireless ad hoc networks or MANETs can take any form of network topology. Mesh networks can relay messages using either a flooding technique or a routing technique. With routing, the message is propagated along a path by hopping from node to node until it reaches its destination.

In some aspects, the computing device 500 may include a display 550 to send visual information to a user. In various aspects, the display 550 may be a cathode ray tube (CRT), a liquid crystal display (LCD), a thin film transistor liquid crystal display (TFT-LCD), and an organic light emitting diode (OLED) display. In certain aspects, the OLED display is a passive-matrix OLED (PMOLED) or active-matrix OLED (AMOLED) display. In aspects, the display 550 is a plasma display, and a video projector. In various aspects, the display 550 may be interactive (e.g., having a touch screen or a sensor such as a camera, a 3D sensor, a LiDAR, a radar, etc.) that can detect user interactions/gestures/responses and the like.

In some aspects, the computing device 500 may include one or more modules. As used herein, the term “module” and like terms are used to indicate a self-contained hardware component of the central server, which in turn includes software modules. In software, a module is a part of a program. Programs are composed of one or more independently developed modules that are not combined until the program is linked. A single module can contain one or several routines, or sections of programs that perform a particular task.

As used herein, the computing device 500 may include software modules for managing various aspects and functions of the disclosed system or components thereof.

In some aspects, computing device 500 includes an operating system configured to perform executable instructions. The operating system is, for example, software, including programs and data, which manages hardware of the disclosed apparatus and provides services for execution of applications for use with the disclosed apparatus. Those of skill in the art will recognize that suitable operating systems include, by way of non-limiting examples, FreeBSD®, OpenBSD, NetBSD®, Linux®, Apple® Mac OS X Server®, Oracle® Solaris®, Windows Server®, Novell® NetWare®, iOS®, and Android®. In some aspects, the operating system is provided by cloud computing.

The term “application” may include a computer program designed to perform particular functions, tasks, or activities for the benefit of a user. Application may refer to, for example, software running locally or remotely, as a standalone program or in a web browser, or other software which would be understood by one skilled in the art to be an application. An application may run on the disclosed controllers or on a user device, including for example, on a mobile device, an IOT device, or a server system.

Any of the herein described methods, programs, algorithms, or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Verilog, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The phrases “in an aspect,” “in aspects,” “in various aspects,” “in some aspects,” or “in other aspects” may each refer to one or more of the same or different aspects in accordance with the present disclosure. Similarly, the phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed is:

1. A management apparatus for managing content for a plurality of repositories including a first repository and a second repository, the management apparatus comprising:
a processor; and
a memory including instructions stored thereon that, when executed by the processor, cause the management apparatus to:
receive an access token from an identity server for a user, wherein the access token allows the user to login to the plurality of repositories via the management apparatus;
receive first content for the first repository and second content for the second repository from the user;
receive metadata for the first content and the second content from the user;
add the metadata to the first content and the second content; and
upload the first content and the second content with the metadata to the first repository and the second repository, respectively.

2. The management apparatus according to claim 1, wherein the access token expires after a first predetermined period.

3. The management apparatus according to claim 2, wherein the access token is to be refreshed after expiration.

4. The management apparatus according to claim 3, wherein the refreshed token expires after a second predetermined period.

5. The management apparatus according to claim 1, wherein the access token is not saved in the management apparatus.

6. The management apparatus according to claim 1, wherein the instructions, when executed by the processor, further cause the management apparatus to:
receive a change in metadata of content uploaded to a repository from the user; and
upload the content with the change in metadata to the repository.

7. The management apparatus according to claim 1, wherein the first content and the second content are related to a project and a group of project members.

8. The management apparatus according to claim 1, wherein the management apparatus does not save the first content, the second content, and the metadata in the management apparatus.

9. The management apparatus according to claim 1, wherein the access token includes location information and login information of the plurality of repositories.

10. The management apparatus according to claim 9, wherein the login information is retrievable from the access token.

11. The management apparatus according to claim 1, wherein the plurality of repositories are incompatible from each other.

12. A method for controlling a management apparatus, which manages content for a plurality of repositories including a first repository and a second repository, the method comprising:
receiving an access token from an identity server for a user, wherein the access token allows the user to login to the plurality of repositories via the management apparatus;
receiving first content for the first repository and second content for the second repository from the user;
receiving metadata for the first content and the second content from the user;
adding the metadata to the first content and the second content; and
uploading the first content and the second content with the metadata to the first repository and the second repository, respectively.

13. The method according to claim 12, wherein the access token expires after a first predetermined period.

14. The method according to claim 13, wherein the access token is to be refreshed after expiration.

15. The method according to claim 14, wherein the refreshed token expires after a second predetermined period.

16. The method according to claim 12, wherein the access token is not saved in the management apparatus.

17. The method according to claim 12, wherein the method further comprises:
receiving a change in metadata of the content uploaded to a repository from the user; and
uploading the content with the change in metadata to the repository.

18. The method according to claim 12, wherein the first content and the second content are related to a project and a group of project members.

19. The method according to claim 12, wherein the first content, the second content, and the metadata are not saved in the management apparatus.

20. The method according to claim 12, wherein the access token includes storing location information and login information of the plurality of repositories.

21. The method according to claim 20, wherein the login information is retrievable from the access token.

22. The management apparatus according to claim 12, wherein the plurality of repositories are incompatible from each other.

23. A nontransitory computer readable medium having instructions thereon that, when executed by a processor, cause the processor to perform a method for controlling a management apparatus, which manages content for a plurality of repositories, the method comprising:
receiving an access token from an identity server for a user, wherein the access token allows the user to login to the plurality of repositories via the management apparatus;
receiving first content for a first repository and second content for a second repository from the user;
receiving metadata for the first content and the second content from the user;
adding the metadata to the first content and the second content; and
uploading the first content and the second content with the metadata to the first repository and the second repository, respectively.
